(19) United States
(12) Patent Application Publication
(10) Pub. No.: US 2026/0081905 A1
(43) Pub. Date: Mar. 19, 2026

(54) SYSTEM AND METHOD FOR SOCIAL MEDIA AUTHENTICITY ANALYSIS AND COORDINATED INFLUENCE DETECTION

(71) Applicant: Clemson University, Clemson, SC (US)

(72) Inventors: Darren Linvill, Clemson, SC (US); Patrick Warren, Clemson, SC (US)

(73) Assignee: Clemson University, Clemson, SC (US)

(21) Appl. No.: 19/330,697

(22) Filed: Sep. 16, 2025

Related U.S. Application Data
(60) Provisional application No. 63/695,546, filed on Sep. 17, 2024.

(51) Int. Cl. H04L 9/40; G06Q 50/00

(52) U.S. Cl. CPC H04L 63/08; G06Q 10/40; H04L 63/102

(57) ABSTRACT

This is a system for authenticity analysis of social media activity having flags that can represent an indicator that a social media account may be participating in a coordinated influence operation, and a computer system in communication with social media platforms. The computer system identifies conversation topics, searches for indicators that social media accounts are involved with conversation topics, determines sets of social media accounts related to the conversation topics, assigns one or more flags to social media accounts according to account attributes, determines if sets of social media accounts are attempting to exert influence on objects of influence within the conversation topics through statistical analysis of flag distributions, and provides subsets of social media accounts suspected of exerting coordinated influence. The system employs statistical outlier detection to identify anomalous objects of influence, enables detection of coordinated networks and distinguishes between authentic coordination and malicious manipulation using behavioral pattern analysis.

### RELATED APPLICATIONS

This application claims priority to U.S. Application No. 63/695,546, titled SYSTEM FOR AUTHENTICITY ANALYSIS FOR SOCIAL MEDIA ACTIVITY, filed Sep. 17, 2024, which is hereby incorporated by reference in its entirety.

### BACKGROUND

### 1) Field of the Invention

The present disclosure relates to computerized systems for analyzing social media activity, and more particularly to a system for detecting coordinated influence operations on social media platforms through statistical analysis of account behaviors and objects of influence.

### 2) Description of Related Art

Social media platforms have become primary channels for information dissemination and public discourse, with billions of users worldwide engaging in conversations on topics ranging from politics and current events to consumer products and entertainment. Current social media monitoring systems primarily rely on individual account analysis and content-based detection methods to identify inauthentic behavior. These systems typically examine account metadata, posting patterns, and content similarity to flag suspicious activity. Traditional approaches focus on detecting bot accounts through behavioral signatures such as posting frequency, account age, and follower-to-following ratios. Content analysis methods examine textual patterns, duplicate messaging, and coordinated timing to identify potential manipulation campaigns.

However, these conventional detection methods face substantial limitations in identifying sophisticated coordinated influence operations. Current systems often produce high false positive rates when analyzing legitimate coordinated activities, such as grassroots political movements or viral marketing campaigns. Additionally, existing approaches struggle to distinguish between organic coordination and malicious manipulation, particularly when bad actors adapt their tactics to mimic authentic user behavior. Traditional account-centric analysis methods fail to capture the broader context of influence campaigns that may span multiple topics and employ diverse tactics across different time periods. Furthermore, current detection systems lack the capability to analyze the complex relationships between accounts, topics, and objects of influence in a unified framework, limiting their effectiveness against evolving manipulation strategies.

The increasing sophistication of coordinated influence operations and the scale of modern social media platforms create an urgent need for more advanced detection methodologies. As malicious actors develop more nuanced approaches to information manipulation, including the use of authentic-appearing accounts and subtle coordination patterns, traditional detection methods become increasingly inadequate. Research efforts must focus on developing comprehensive analytical frameworks that can identify coordinated behavior through statistical analysis of influence patterns rather than relying solely on individual account characteristics. There is a pressing need for systems that can analyze the intersection of account behaviors, content themes, and temporal patterns to detect coordinated influence operations while minimizing false positives from legitimate coordinated activities.

It is therefore an object of the present invention to provide a computerized system for authenticity analysis that addresses the limitations of current detection methods by implementing statistical anomaly detection around objects of influence to expose coordinated account networks while revealing behavioral patterns and influence tactics across social media platforms.

It is another object of the present invention to provide a method for identifying coordinated influence operations through the analysis of flag distributions across objects of influence, enabling the detection of suspicious account clusters that contribute to outlier objects in ways that deviate from expected organic patterns.

It is a further object of the present invention to provide a system that can distinguish between authentic coordination and malicious manipulation by analyzing the mix of accounts contributing to specific objects of influence, thereby reducing false positives while maintaining high detection accuracy for genuine coordinated influence operations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a computerized system for authenticity analysis of social media activity is provided. The computerized system comprises a computer device configured to receive social media data from a social media platform. The computerized system comprises a memory configured to store a set of flags, wherein each flag represents an indicator that a social message may be sent by an account participating in a coordinated influence operation. The computer device is further configured to identify a topic within the social media data. The computer device is further configured to define a set of objects of influence within the topic. The computer device is further configured to assign one or more flags from the set of flags to social media messages based on account and message attributes. The computer device is further configured to calculate rates at which the flags appear connected to each object of influence. The computer device is further configured to perform statistical analysis to detect outlier objects of influence based on flag distributions that deviate from expected patterns. The computer device is further configured to identify accounts that contribute to the outlier objects of influence as suspected of participating in coordinated influence operations. The computer device is further configured to display on a display the identified accounts.

According to other aspects of the present disclosure, the computerized system may include one or more of the following features. The flags may comprise indicators of automation including hyperactivity patterns, implausibly regular output schedules, birth bunch, narrow retweeter, low follower, usage of automation-friendly client applications and any combination. The hyperactivity patterns may be detected by analyzing posting frequency that exceeds expected human behavior thresholds. The objects of influence may comprise hashtags, external domains, named entities, account mentions, narrative themes and any combination identified through natural language processing techniques. The narrative themes may be identified using Large Language Model-based topic modeling approaches that analyze terms appearing together with statistical significance. The computer device may be further configured to link accounts that contribute to the same outlier object of influence and share the flag that caused the object to be identified as an outlier. The computer device may be further configured to identify secondary linkages between accounts that simultaneously contribute to multiple outlier objects exhibiting similar statistical anomalies.

According to another aspect of the present disclosure, a computerized method for detecting coordinated influence operations on social media platforms is provided. The computerized method comprises receiving social media data from a social media platform. The computerized method comprises storing a set of flags, wherein each flag represents an indicator that a social media account may be participating in a coordinated influence operation. The computerized method comprises identifying a topic within the social media data. The computerized method comprises defining a set of objects of influence within the topic. The computerized method comprises assigning one or more flags from the set of flags to social media accounts based on account attributes. The computerized method comprises calculating rates at which the flags appear connected to each object of influence. The computerized method comprises performing statistical analysis to detect outlier objects of influence based on flag distributions that deviate from expected patterns. The computerized method comprises identifying accounts that contribute to the outlier objects of influence as suspected of participating in coordinated influence operations. The computerized method comprises providing the identified account to a user for subsequent action by the user.

According to other aspects of the present disclosure, the computerized method may include one or more of the following features. The flags may comprise indicators of automation including hyperactivity patterns, implausibly regular output schedules, birth bunch, narrow retweeter, low follower, usage of automation-friendly client applications and any combination. The hyperactivity patterns may be detected by analyzing posting frequency that exceeds expected human behavior thresholds. The objects of influence may comprise hashtags, external domains, named entities, account mentions, narrative themes and any combination identified through natural language processing techniques. The narrative themes may be identified using Large Language Model-based topic modeling approaches that analyze terms appearing together with statistical significance. The computerized method may further comprise a step of linking accounts that contribute to the same outlier object of influence and share the flag that caused the object to be identified as an outlier. The computerized method may further comprise a step of identifying secondary linkages between accounts that simultaneously contribute to multiple outlier objects exhibiting similar statistical anomalies.

According to another aspect of the present disclosure, a computer device having a computer readable medium and computer readable instructions is provided. When executed by a processor, the computer readable instructions comprise receiving a social media data from one or more social media platforms. The computer readable instructions comprise storing a set of flags, wherein each flag represents an indicator that a message comes from a social media account that may be participating in a coordinated influence operation. The computer readable instructions comprise identifying a topic within the social media data. The computer readable instructions comprise defining a set of objects of influence within the topic. The computer readable instructions comprise assigning one or more flags from the set of flags to social media messages as a function of the characteristics of those messages and the social media accounts that sent them. The computer readable instructions comprise calculating rates at which the flags appear connected to each object of influence. The computer readable instructions comprise performing statistical analysis to detect outlier objects of influence based on flag distributions that deviate from expected patterns. The computer readable instructions comprise identifying accounts that contribute to the outlier objects of influence as suspected of participating in coordinated influence operations.

The foregoing general description of the illustrative embodiments and the following detailed description thereof are merely exemplary aspects of the teachings of this disclosure and are not restrictive.

### BRIEF DESCRIPTION OF FIGURES

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 illustrates a flowchart for a social media authenticity analysis process, according to aspects of the present disclosure.

FIG. 2 depicts a graphical representation of a topic containing multiple categorized elements, according to an embodiment.

FIG. 3 illustrates a system diagram showing relationships between narratives within the topic of FIG. 2, according to aspects of the present disclosure.

FIG. 4A depicts histograms showing frequency distributions of social media account activity, according to an embodiment.

FIG. 4B depicts additional histograms showing frequency distributions of social media activity patterns, according to aspects of the present disclosure.

FIG. 5 illustrates a flowchart for analyzing social media activity, according to an embodiment.

FIG. 6 illustrates a system for analyzing social media activity patterns and content, according to aspects of the present disclosure.

FIG. 7 depicts a data visualization showing sender tweets by hour across multiple social media accounts, according to an embodiment.

FIG. 8 illustrates a system diagram for authenticity analysis of social media activity, according to aspects of the present disclosure.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Social media platforms have become primary channels for information dissemination and public discourse, creating opportunities for both legitimate communication and coordinated manipulation. The proliferation of automated accounts, coordinated messaging campaigns, and inauthentic behavior patterns presents challenges for identifying genuine versus manipulated content. Traditional approaches to detecting coordinated influence operations often focus on individual account characteristics or network-based analysis, which may be limited in scope and adaptability.

A computerized system for authenticity analysis addresses these challenges by analyzing patterns across multiple dimensions of social media activity. The system examines coordinated influence operations through statistical analysis of account behaviors, content patterns, and temporal distributions. Rather than relying solely on individual account metrics, the system evaluates how different types of accounts contribute to specific objects of influence within social media discourse. Objects of influence may include hashtags, external domains, named entities, or narrative themes that become focal points for coordinated messaging campaigns.

The system may operate across multiple social media platforms simultaneously, enabling cross-platform analysis of coordinated activities. This multi-platform approach allows for detection of influence operations that span different social media environments and may exhibit coordinated behavior patterns across platforms. Cross-platform analysis may reveal connections between accounts and campaigns that would not be apparent when examining individual platforms in isolation.

Privacy protection and civil liberties considerations are addressed through data handling approaches that maintain analytical capability while protecting individual privacy. Account names and identifying information may be hashed or obfuscated until sufficient evidence of inauthenticity is found. This approach allows the system to perform statistical analysis and pattern detection without exposing individual account identities during preliminary analysis phases. The obfuscation process may be reversed only when statistical evidence indicates potential coordinated inauthentic behavior, providing a balance between analytical effectiveness and privacy protection.

The system employs a multi-step analytical process that begins with topic identification and proceeds through object definition, flag assignment, and statistical outlier detection. This systematic approach enables the identification of coordinated influence operations through probabilistic analysis rather than deterministic rules. The analytical framework may adapt to different types of influence operations and evolving tactics used by coordinated actors, providing flexibility in detection capabilities across various social media environments and campaign types.

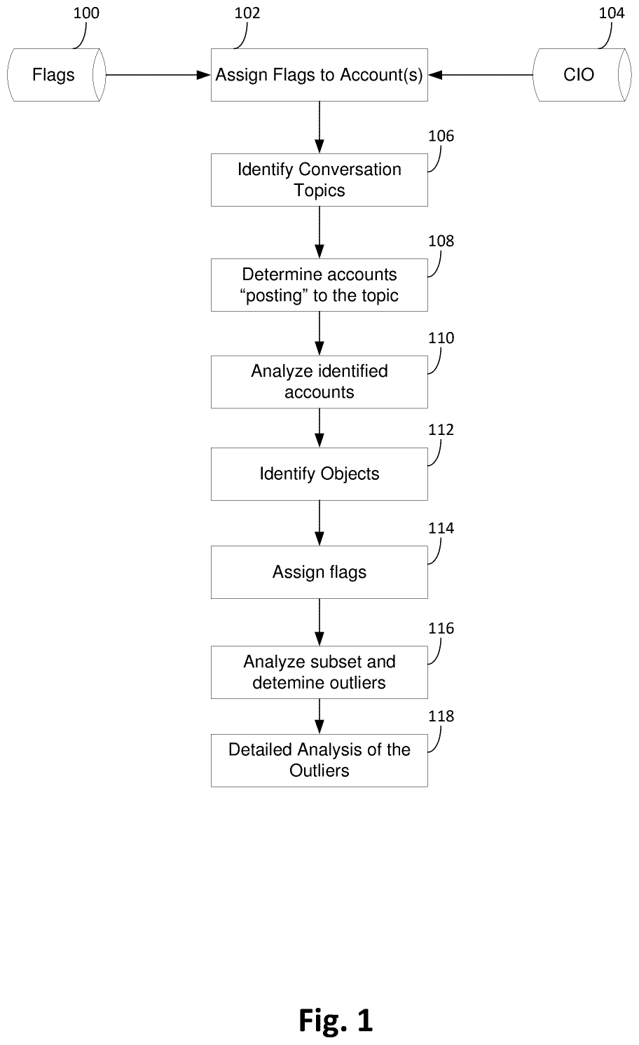

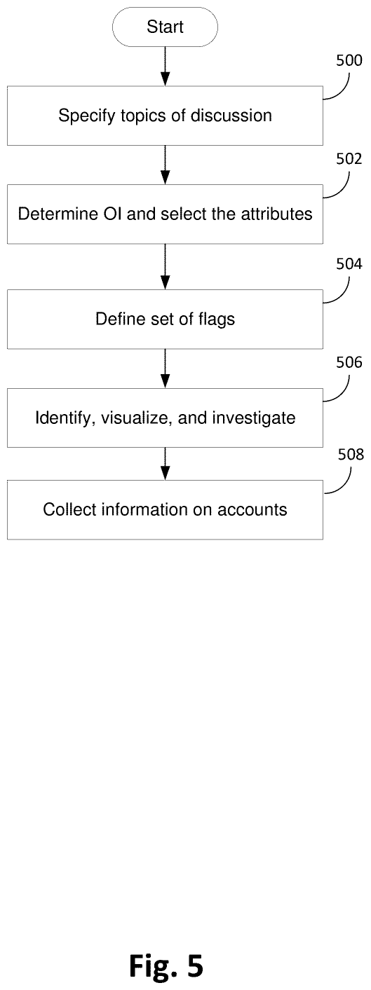

With reference to FIG. 1 and FIG. 5, the social media authenticity analysis system operates through a sequential methodology that processes social media data to identify coordinated influence operations. The system begins with a set of flags 100 that serve as indicators for detecting messages from accounts potentially participating in a coordinated influence operation 104. A message from an account 102 may be assigned one or more flags 100 based on behavioral characteristics, content patterns, or statistical anomalies observed in the originating account's activity or from patterns in the technical characteristics of the message itself, perhaps in juxtaposition with other messages. The flags 100 may include indicators of automation such as hyperactivity patterns, implausibly regular output schedules, or usage of automation-friendly client applications. Flags can include determining ids accounts are a birth-bunch which means that these accounts have a common birth date within the set of accounts active on the topic. Flags can include a narrow retweeter meaning that the account retweets or reposts, a very small set of original accounts. Flags can include that the account a number of followers that falls below a minimal or a low number of followers. Flags can include superficial polish and deeper inconsistencies in the account information. Flags can include sparse or generic profile information, such as a vague bio, a profile photo that appears AI-generated or lifted from stock imagery, and a username that mimics a real person or brand but includes subtle alterations like extra characters or misspellings. Flags can include posting behavior that tends to be erratic or overly promotional, with frequent reposts, excessive hashtags, and comments that are automated or irrelevant to the content. Flags can include engagement metrics such as a disproportionate follower-to-post ratio, or followers might consist of similarly suspicious accounts. Flags can include a tone and content that lacks coherence, transitioning between unrelated topics or using awkward phrasing that suggests non-native language generation or bot activity. Flags that can indicate impersonation can include attempts to solicit money, promote dubious links, engage in sock-puppet behavior, defend or attack others while claiming an independent voices.

Additional flags 100 may identify coordination indicators including similar content across multiple accounts, matching account descriptions, synchronized creation dates, or identical account imagery. The coordinated influence operation 104 represents the target phenomenon that the system seeks to detect through statistical analysis of flag distributions across different objects of influence.

The process continues with topic identification at step 106, where the system defines social media conversations or discourse areas that may be targets of coordinated manipulation. A topic may be defined using a random sample of posts rather than analyzing complete populations of posts over specified time periods, allowing for efficient processing of large-scale social media datasets. The topic may include all posts shared by a given set of accounts rather than relying solely on keyword-based selection criteria. This approach enables the system to capture coordinated activities that may not be immediately apparent through traditional keyword filtering methods. The system then proceeds to step 108 where accounts posting to the identified topic are determined and catalogued for subsequent analysis.

Account analysis occurs at step 110, where the system examines behavioral patterns and characteristics of accounts contributing to the identified topic. The analysis may include evaluation of posting time patterns, including detection of posts arriving in the first second of each minute as a coordination indicator that suggests automated or synchronized posting behavior. Account creation dates occurring in batches may be used as an indicator of coordinated influence operations, as legitimate users typically create accounts at random intervals rather than in synchronized groups. The system may analyze message-level data including content derivatives, message statistics, originator statistics, target statistics, and impact metrics to build comprehensive profiles of account behavior patterns.

As shown in FIG. 5, the process advances to step 502 where objects of influence and their associated attributes are determined and selected within the identified topic. Objects of influence may be inferred through supervised machine-learning processes in addition to unsupervised approaches, providing flexibility in detection methodologies. Hybrid approaches may be used for object identification that iterate between narrative detection and hand labeling, combining automated analysis with human expertise to refine object definitions. The system may employ Large Language Model-based topic modeling approaches to identify narrative-frame objects of influence by analyzing terms that appear together with statistical significance. Objects of influence may include named entities, hashtags, accounts, external domains, or narrative themes that serve as focal points for coordinated messaging campaigns.

The methodology concludes with outlier detection processes that identify statistical anomalies in the distribution of flags 100 across different objects of influence. At step 504, the system defines the complete set of flags 100 that will be used for statistical analysis, establishing the behavioral indicators that will be measured across the dataset. The system calculates rates at which flags 100 appear connected to each object of influence over specified time periods, generating statistical distributions that represent normal versus anomalous patterns of account behavior. Statistical analysis techniques may include both frequentist and Bayesian approaches for outlier detection, providing multiple analytical frameworks for identifying coordinated activities. The system performs this functionality as a process by systematically filtering and analyzing data through each sequential step, with computer processors executing algorithmic operations on digital data structures to identify patterns indicative of coordinated influence operations.

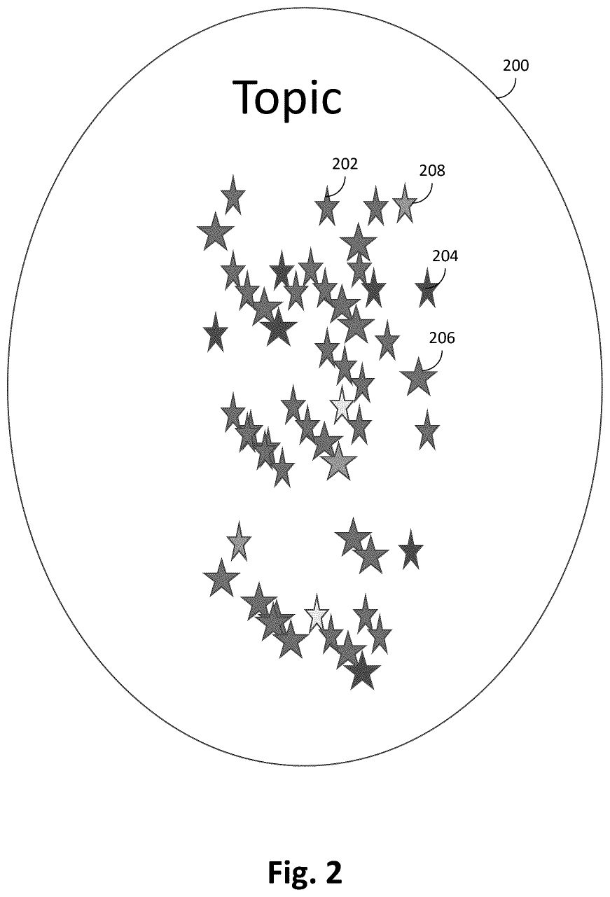

Referring to FIG. 2, the system processes social media data through topic categorization mechanisms that organize content into analytical frameworks for coordinated influence detection. A topic 200 represents a defined area of social media discourse that may be subject to coordinated manipulation activities. The topic 200 encompasses multiple categories of behavioral indicators that the system analyzes to identify patterns of inauthentic activity. A category 202 within the topic 200 represents baseline message-level data that includes content derivatives, message statistics, originator statistics, target statistics, and impact metrics associated with normal social media activity patterns. The system analyzes these message-level data components to establish statistical baselines against which anomalous behaviors may be detected through comparative analysis processes.

The topic 200 includes specialized behavioral indicators that serve as flags 100 for detecting coordinated activities. Botishness 204 represents automated behavior patterns within the topic 200 that may indicate the presence of bot accounts or automated posting systems. The botishness 204 category encompasses hyperactivity patterns, regular posting intervals, and other characteristics that suggest non-human account operation. Flooding 206 represents high-volume content generation patterns within the topic 200 that may indicate coordinated messaging campaigns designed to amplify specific narratives or suppress opposing viewpoints. New account creation 208 within the topic 200 identifies patterns of synchronized account generation that may indicate the establishment of coordinated influence networks. The system analyzes temporal patterns in new account creation 208 to detect batch creation events that suggest coordinated preparation for influence operations.

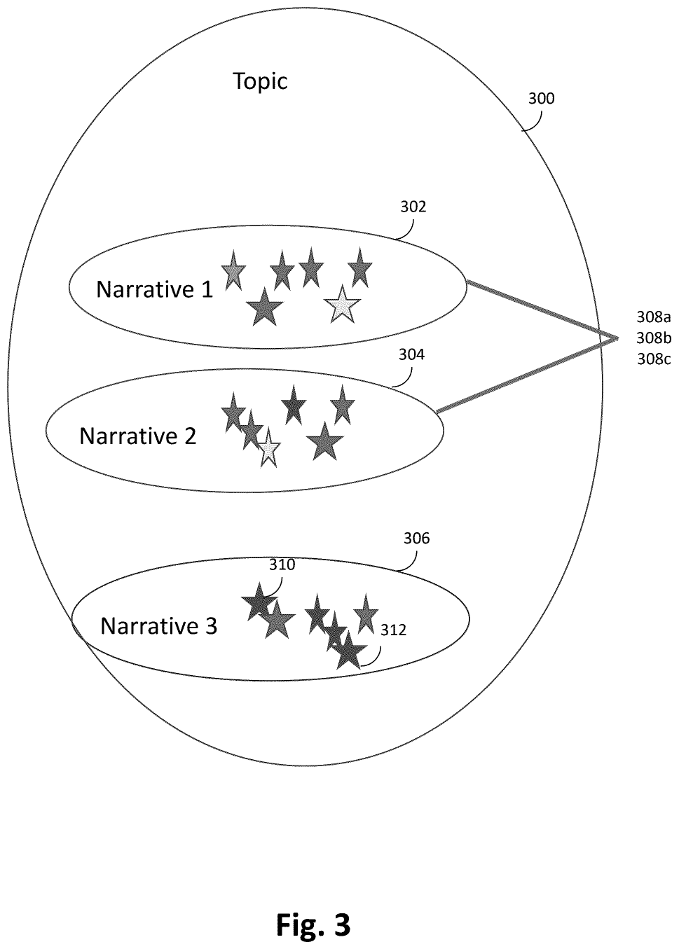

With reference to FIG. 3, the system performs narrative analysis within topic structures to identify coordinated influence patterns through statistical examination of content relationships and account behaviors. A topic 300 contains multiple narrative components that represent different thematic elements within the broader discourse area. A first narrative 302 and a second narrative 304 represent legitimate discourse patterns within the topic 300 that exhibit normal statistical distributions of account behaviors and content characteristics. The first narrative 302 and second narrative 304 serve as baseline comparisons for identifying anomalous patterns that may indicate coordinated manipulation activities. The system analyzes these narratives using Large Language Model-based topic modeling approaches to infer narrative-frame objects of influence by examining terms and concepts that appear together with statistical significance across the dataset.

The narrative analysis process identifies statistical outliers through examination of message distribution patterns and temporal characteristics associated with different narrative components. A message distribution 308a represents the statistical spread of content characteristics across accounts contributing to the first narrative 302 and second narrative 304. A temporal distribution 308b captures time-based patterns of posting activity associated with the narratives, enabling detection of synchronized or coordinated timing patterns that may indicate inauthentic behavior. A joint distribution 308c combines multiple statistical measures to provide comprehensive analysis of how different behavioral indicators correlate within the narrative structures. The system employs both frequentist and Bayesian approaches for outlier detection, analyzing these distributions to identify narrative components that deviate from expected statistical patterns with significance levels that suggest coordinated manipulation.

An outlier narrative 306 within the topic 300 represents a narrative component that exhibits statistical anomalies indicating potential coordinated influence activity. The outlier narrative 306 contains accounts that demonstrate behavioral patterns significantly different from those observed in the first narrative 302 and second narrative 304. A first outlier account 310 and a second outlier account 312 contribute to the outlier narrative 306 and exhibit coordinated behaviors that trigger statistical detection algorithms. The first outlier account 310 and second outlier account 312 may demonstrate synchronized posting patterns, similar content generation, or other behavioral indicators that suggest participation in a coordinated influence operation 104. The system analyzes relationships between the first outlier account 310 and second outlier account 312 to determine whether these accounts represent components of a broader coordinated network operating within the topic 300. Objects of influence within the outlier narrative 306 may include named entities, hashtags, accounts, external domains, or narrative themes that serve as focal points for the coordinated messaging activities detected through the statistical analysis processes.

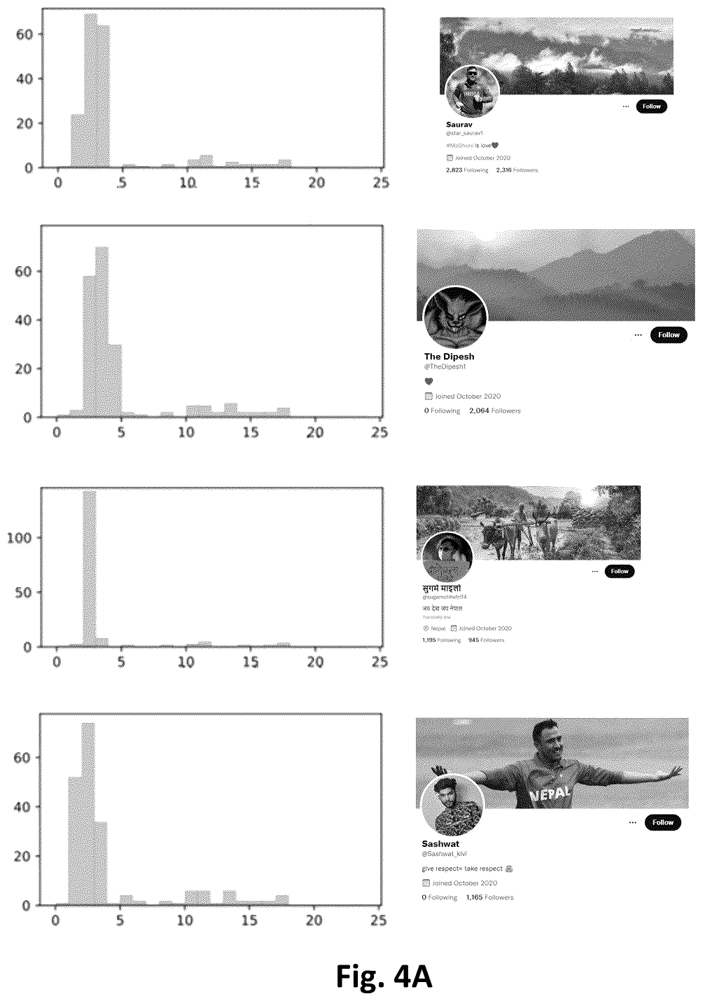

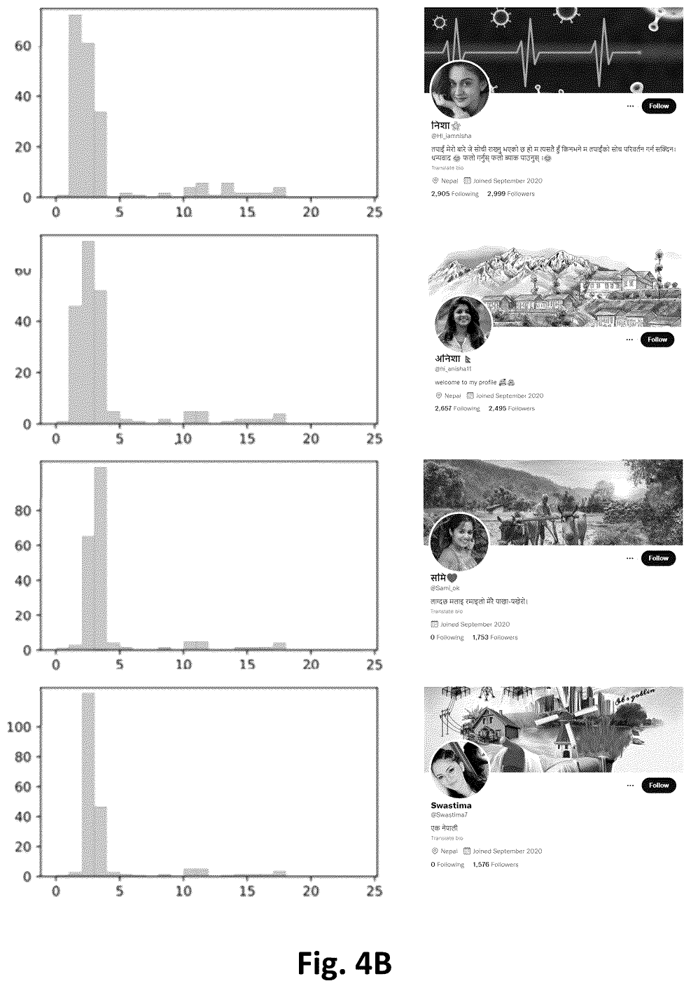

As shown in FIG. 4A and FIG. 4B, the computerized system provides histogram displays that visualize frequency distributions of social media account activity patterns across temporal intervals. The histogram displays present statistical data showing activity levels on vertical axes with time intervals represented on horizontal axes, enabling analysts to identify patterns that may indicate coordinated behavior among accounts participating in influence operations. FIG. 4A depicts four vertically stacked histograms showing right-skewed distributions with peaks occurring in lower activity ranges, suggesting normal user behavior patterns where most accounts exhibit moderate activity levels. The histogram displays in FIG. 4A demonstrate frequency counts ranging from zero to approximately one hundred, with the majority of account activity concentrated in the zero to five range across all four distribution samples. FIG. 4B illustrates similar histogram structures with yellow-colored bar representations, where the top histogram shows peak frequencies of approximately sixty while subsequent histograms display progressively lower peak frequencies, indicating temporal variations in account activity patterns that the system analyzes for coordination indicators.

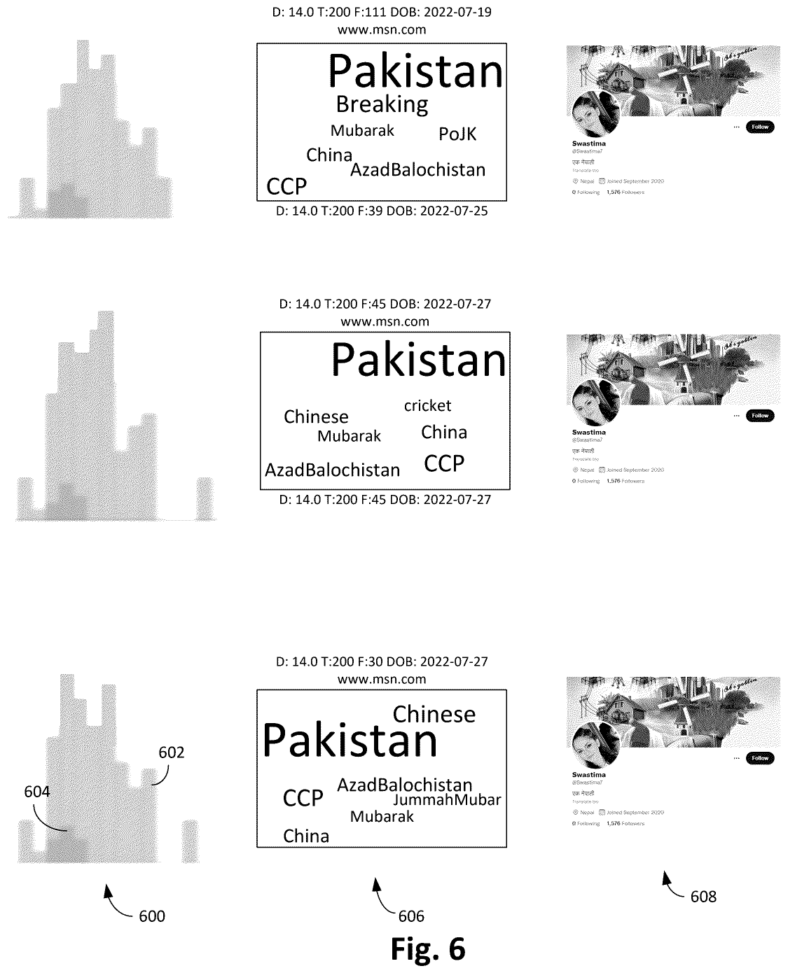

With reference to FIG. 6, the computerized system incorporates an activity timeline 600 that processes and displays temporal posting patterns for social media accounts under analysis. The activity timeline 600 comprises web application posts 602 and android application posts 604, which enable the system to differentiate posting behaviors based on the client applications used to generate social media content. The web application posts 602 and android application posts 604 are represented in distinct sections within the activity timeline 600, allowing analysts to compare posting behaviors across different platform access methods and identify potential automation patterns that may indicate coordinated influence operations. The activity timeline 600 displays posting patterns over specified time periods, with the web application posts 602 and android application posts 604 providing granular data about when and how accounts generate content across different access platforms. The system analyzes temporal distributions between the web application posts 602 and android application posts 604 to detect synchronized posting behaviors that may suggest automated or coordinated account operation rather than organic human activity patterns.

The computerized system includes a content analysis module 606 that processes and analyzes textual elements of social media posts, including hashtags, keywords, and narrative themes that may serve as objects of influence within coordinated messaging campaigns. The content analysis module 606 examines linguistic patterns, semantic relationships, and content similarity across multiple accounts to identify coordinated messaging activities that may indicate inauthentic behavior. A profile analysis module 608 operates in conjunction with the content analysis module 606 to examine account characteristics and presentation aspects that may indicate coordinated account creation or management. The profile analysis module 608 analyzes profile images, account descriptions, creation dates, and other metadata associated with social media accounts to identify patterns that suggest batch account creation or coordinated profile management activities. The content analysis module 606 and profile analysis module 608 work together to provide comprehensive analysis capabilities that examine both the substance of social media communications and the characteristics of accounts generating such communications, enabling detection of coordinated influence operations through multiple analytical dimensions.

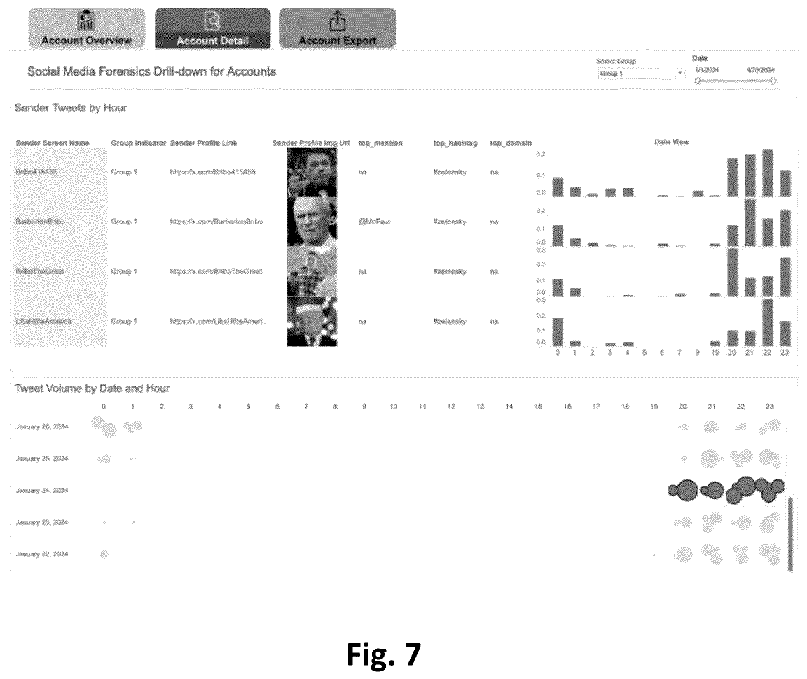

As illustrated in FIG. 7, the computerized system provides temporal posting pattern visualization that displays sender tweet activity across twenty-four hour periods for multiple social media accounts simultaneously. The visualization includes tabular data on the left side displaying sender screen names and group indicators alongside profile images, while corresponding time-series graphs on the right side illustrate tweet activity patterns with distinct peaks occurring primarily during later hours between twenty and twenty-three. The temporal posting pattern visualization organizes data into separate rows for different sender accounts, with each row containing activity patterns represented by blue bars of varying heights indicating tweet volume at different hourly intervals. The system analyzes these temporal patterns to detect synchronized posting behaviors that may indicate coordinated account operation, as legitimate users typically exhibit varied posting schedules while coordinated accounts may demonstrate similar temporal activity patterns. Statistical grouping and visualizations of account behavior highlight elements that link suspicious accounts together through temporal correlation analysis, content similarity measures, and behavioral pattern matching algorithms that identify accounts operating with coordinated timing or messaging strategies. The flags 100 may include reverse indicators that indicate account authenticity, such as platform verification status, plausible geocoding data that correlates with stated account locations, and links from reliable external homepages that provide independent verification of account legitimacy, enabling the system to distinguish between authentic coordinated activities and inauthentic influence operations through comprehensive behavioral and verification analysis processes.

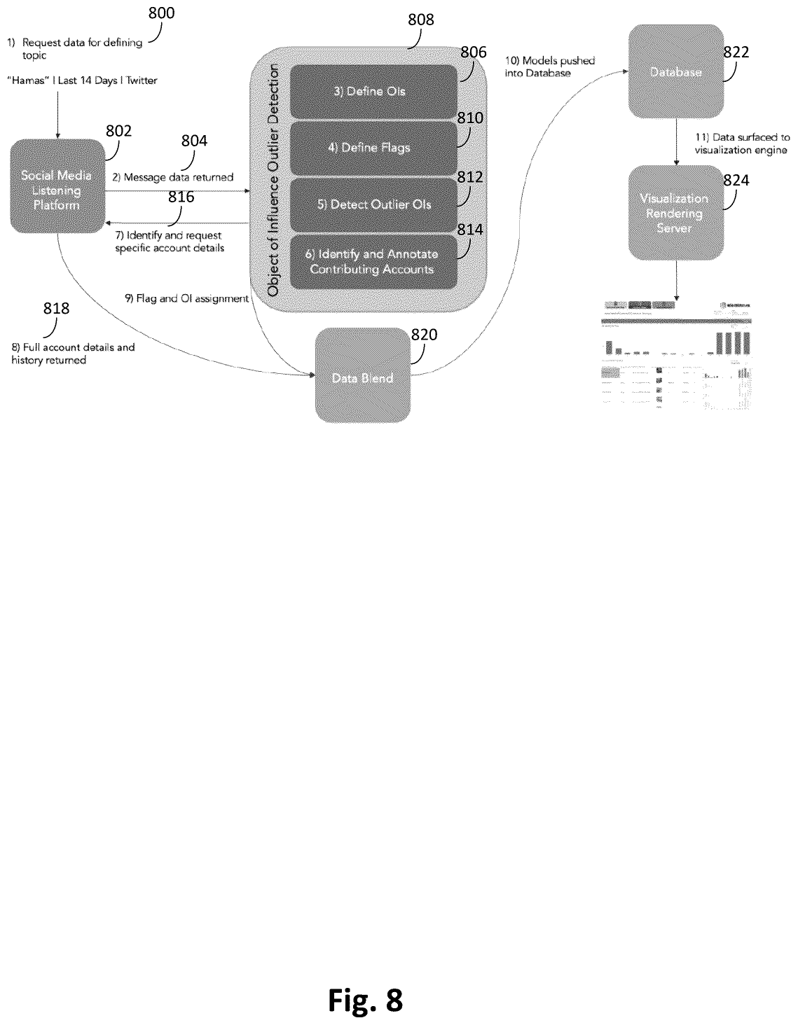

With reference to FIG. 8, the computerized system employs a distributed architecture that processes social media data through interconnected components designed to detect coordinated influence operations through systematic data collection, analysis, and visualization processes. The system architecture facilitates the identification of inauthentic social media activities by processing large-scale datasets through specialized analytical engines and data management components. A topic request 800 initiates the analytical process by specifying the social media discourse areas or conversation topics that require investigation for potential coordinated manipulation activities. The topic request 800 may define specific keywords, hashtags, time periods, or account sets that establish the boundaries for data collection and analysis operations. The system processes the topic request 800 through automated workflows that coordinate data retrieval, analysis, and reporting functions across multiple system components operating in parallel processing configurations.

A social media listening platform 802 serves as the primary data ingestion interface that connects the system to external social media platforms and data sources. The social media listening platform 802 receives the topic request 800 and executes data collection operations across specified social media environments to gather relevant posts, account information, and metadata associated with the requested topics. The social media listening platform 802 may interface with multiple social media platforms simultaneously, enabling cross-platform analysis of coordinated activities that span different social media environments. The platform implements application programming interfaces and data streaming protocols that facilitate real-time or batch data collection processes depending on the analytical requirements specified in the topic request 800. The social media listening platform 802 returns message data 804 that contains the collected social media posts, account details, temporal information, and associated metadata required for subsequent analytical processing steps.

The message data 804 represents the foundational dataset that contains social media posts, account characteristics, posting timestamps, content elements, and engagement metrics collected from the social media listening platform 802. The message data 804 may include textual content, multimedia elements, hashtags, mentions, external links, and other structural components of social media communications that provide analytical inputs for coordinated influence detection algorithms. The system processes the message data 804 through data normalization and standardization procedures that prepare the collected information for statistical analysis and pattern detection operations. The message data 804 flows through multiple analytical pathways within the system architecture, enabling parallel processing of different analytical dimensions including content analysis, temporal pattern detection, and account behavior evaluation. The message data 804 may be filtered, aggregated, or transformed based on the analytical requirements specified in the topic request 800 and the detection algorithms employed by downstream system components.

An object of influence outlier detection engine 808 processes influence objects 806 to identify statistical anomalies that may indicate coordinated manipulation activities within the collected social media data. The influence objects 806 represent specific elements within the message data 804 that may serve as focal points for coordinated messaging campaigns, including hashtags, external domains, named entities, account mentions, or narrative themes identified through natural language processing techniques. The object of influence outlier detection engine 808 applies statistical analysis algorithms to examine how different types of accounts contribute to the influence objects 806, calculating distribution patterns and identifying deviations from expected statistical norms. The engine employs both supervised and unsupervised machine learning approaches to detect coordinated activities, analyzing temporal patterns, content similarity measures, and account behavior correlations across the influence objects 806. The object of influence outlier detection engine 808 generates statistical models that establish baseline patterns for legitimate social media activity and identifies influence objects 806 that exhibit anomalous account contribution patterns suggesting potential coordinated manipulation.

Flag definitions 810 provide the behavioral indicators and statistical thresholds that guide the detection algorithms employed throughout the system architecture. The flag definitions 810 specify the criteria for identifying accounts that may participate in coordinated influence operations, including automation indicators, coordination patterns, targeting behaviors, and statistical anomalies in account characteristics. An outlier detector 812 receives the flag definitions 810 and applies these criteria to the message data 804 and influence objects 806 to identify accounts and content patterns that deviate from normal social media behavior patterns. The outlier detector 812 implements statistical analysis algorithms that calculate flag occurrence rates across different influence objects 806 and identify objects that exhibit statistically improbable distributions of flagged accounts. The outlier detector 812 may employ frequentist statistical methods, Bayesian analysis approaches, or machine learning classification algorithms to distinguish between legitimate coordinated activities and inauthentic influence operations based on the patterns observed in the flag distributions across the influence objects 806.

An account identifier 814 processes the results from the outlier detector 812 to identify and annotate specific social media accounts that contribute to statistically anomalous influence objects 806. The account identifier 814 examines accounts that share flags 100 associated with outlier influence objects 806 and determines linkages between accounts based on their contribution patterns to multiple anomalous objects. The account identifier 814 may group accounts based on behavioral similarities, temporal correlation patterns, or content generation characteristics that suggest coordinated operation within influence campaigns. The system generates account request 816 operations to obtain additional detailed information about accounts identified by the account identifier 814 as potentially participating in coordinated influence operations. The account request 816 may trigger data collection processes that gather comprehensive account histories, posting patterns, network connections, and other detailed characteristics that support deeper analytical investigation of suspected coordinated accounts.

The system discovers account history 818 information that provides comprehensive behavioral profiles for accounts identified through the outlier detection processes. The account history 818 may include complete posting timelines, content generation patterns, engagement behaviors, network connections, and other longitudinal data that enables detailed analysis of account operation patterns over extended time periods. A data blender 820 combines information from multiple analytical components including the message data 804, influence objects 806, flag assignments, outlier detection results, and account history 818 to create integrated datasets for comprehensive analysis and reporting. The data blender 820 implements data fusion algorithms that correlate information across different analytical dimensions and time periods, enabling the system to build comprehensive profiles of coordinated influence operations and their participating accounts. The data blender 820 may apply data quality validation procedures, duplicate detection algorithms, and consistency checking processes to ensure the accuracy and reliability of the integrated analytical datasets.

A system database 822 stores the integrated datasets produced by the data blender 820 along with analytical results, statistical models, and historical information that supports ongoing monitoring and analysis operations. The system database 822 may implement distributed storage architectures that enable scalable data management for large-scale social media datasets and analytical results. The database supports query operations that enable analysts to retrieve specific subsets of data for detailed investigation, comparative analysis, or reporting purposes. A visualization rendering server 824 processes the stored data from the system database 822 to generate interactive displays, statistical charts, network diagrams, and other visual representations that support analytical interpretation and decision-making processes. The visualization rendering server 824 may implement web-based interfaces that enable analysts to explore the data through interactive dashboards, filtering operations, and drill-down capabilities that facilitate detailed investigation of suspected coordinated influence operations. The visualization rendering server 824 generates displays that highlight statistical anomalies, account relationships, temporal patterns, and other analytical insights that support the identification and characterization of coordinated influence activities within social media environments.

The computerized system operates through interconnected data processing workflows that enable comprehensive detection of coordinated influence operations across social media platforms through systematic analysis of account behaviors, content patterns, and statistical distributions. The system processes social media data through multiple analytical pathways that operate in parallel to examine different dimensions of potential coordinated activity, including temporal posting patterns, content similarity measures, account characteristic analysis, and statistical outlier detection across objects of influence. Data flows through the system architecture in structured sequences that begin with topic identification and data collection, proceed through flag assignment and object analysis, and conclude with statistical evaluation and account linking processes that identify coordinated networks operating within social media environments. The system maintains data integrity and analytical accuracy through validation procedures that verify the consistency and reliability of information processed across different analytical components and time periods.

Statistical analysis processes within the system examine distributions of behavioral indicators across objects of influence to identify patterns that deviate from expected norms for legitimate social media activity. The system calculates occurrence rates for different behavioral flags across various objects of influence, generating statistical models that represent baseline patterns for authentic social media discourse within specific topic areas. These statistical models enable the system to identify objects of influence that exhibit anomalous distributions of flagged accounts, indicating potential coordinated manipulation activities that warrant further investigation. The statistical analysis employs multiple analytical approaches including frequentist hypothesis testing, Bayesian inference methods, and machine learning classification algorithms that provide complementary perspectives on the likelihood that observed patterns result from coordinated influence operations rather than organic social media activity.

The system implements sophisticated account linking mechanisms that identify relationships between social media accounts based on their contribution patterns to statistically anomalous objects of influence and their behavioral characteristics across multiple analytical dimensions. Account linking processes examine accounts that contribute to the same outlier objects and share behavioral flags that caused those objects to be identified as statistical anomalies, establishing primary linkage relationships based on direct participation in suspicious activities. The system extends these primary linkages through secondary analysis that identifies accounts contributing to multiple outlier objects that exhibit similar types of statistical anomalies, even when the contributing accounts do not share the specific behavioral flags that caused the individual objects to be classified as outliers. This secondary linking mechanism enables the system to identify coordinated networks that employ diverse tactics or operate across multiple objects of influence while maintaining coordinated messaging strategies.

Account linking may occur when accounts simultaneously contribute to several outlier objects that are outliers in the same way, regardless of sharing flags, enabling the system to detect coordinated operations that employ varied behavioral patterns while maintaining strategic coordination across multiple influence targets. The system analyzes correlation patterns between accounts that contribute to outlier objects exhibiting similar statistical anomalies, identifying accounts that consistently participate in objects characterized by the same types of behavioral flag distributions or temporal patterns. These correlation analyses enable the system to detect coordinated networks that may employ different individual tactics while maintaining coordinated strategic objectives across multiple objects of influence within social media discourse areas. The account linking mechanisms generate network graphs and relationship matrices that visualize connections between accounts based on their participation patterns in anomalous objects of influence, providing analytical frameworks that support detailed investigation of suspected coordinated influence operations.

Data flow coordination within the system ensures that information collected from social media platforms undergoes systematic processing through multiple analytical stages that build comprehensive profiles of potential coordinated influence activities. The system manages data processing workflows that coordinate the timing and sequencing of analytical operations to ensure that statistical models are updated with current information and that account linking analyses incorporate the most recent behavioral data available from monitored social media platforms. The data flow processes implement quality control mechanisms that validate the accuracy and completeness of information processed through different analytical components, ensuring that statistical analyses and account linking operations are based on reliable and consistent datasets. The system maintains audit trails that document the analytical processes applied to specific datasets, enabling analysts to trace the derivation of detection results and validate the statistical foundations for identified coordinated influence operations.

The system coordinates analytical operations across multiple temporal scales to detect coordinated influence activities that may operate over different time horizons or exhibit varying patterns of activity intensity over time. Short-term analysis processes examine posting patterns, content generation, and account behaviors over hourly or daily intervals to detect synchronized activities that may indicate coordinated messaging campaigns or automated account operation. Medium-term analysis extends the temporal scope to weekly or monthly intervals, enabling detection of coordinated campaigns that operate over extended periods or exhibit cyclical patterns of activity that align with specific events or discourse developments. Long-term analysis examines account behaviors and network relationships over months or years, identifying persistent coordinated operations that may adapt their tactics over time while maintaining consistent strategic objectives within targeted social media discourse areas. Integration mechanisms within the system combine results from different analytical components to generate comprehensive assessments of coordinated influence operations that incorporate multiple types of evidence and analytical perspectives. The system correlates findings from content analysis, temporal pattern detection, account behavior evaluation, and statistical outlier identification to build multidimensional profiles of suspected coordinated activities that provide robust foundations for analytical conclusions. These integration processes apply weighting algorithms that account for the reliability and significance of different types of analytical evidence, generating confidence scores that reflect the statistical strength of evidence supporting the identification of coordinated influence operations. The system generates analytical reports that synthesize findings from multiple analytical dimensions, providing comprehensive documentation of detected coordinated activities that supports decision-making processes and further investigative activities by analysts working to understand and counter coordinated influence operations within social media environments.

Natural language processing techniques are computational methods that enable computer systems to analyze, interpret, and extract meaningful information from human language data in textual form. These techniques allow automated systems to process large volumes of social media content and identify patterns, themes, and entities that may be relevant to coordinated influence detection. Examples of natural language processing techniques include named entity recognition, which identifies and extracts specific entities such as person names, organizations, locations, and other proper nouns from social media posts; hashtag extraction and analysis, which identifies trending topics and thematic elements within social media conversations; sentiment analysis, which determines the emotional tone or opinion expressed in textual content; topic modeling approaches that use Large Language Models to identify narrative themes by analyzing terms that appear together with statistical significance; content similarity detection, which compares textual elements across multiple posts to identify coordinated messaging patterns; and keyword extraction methods that identify significant terms and phrases that may serve as objects of influence within social media discourse areas.

Large Language Model-based topic modeling approaches leverage the advanced natural language understanding capabilities of transformer-based models to identify and extract thematic content from social media data through sophisticated contextual analysis and semantic understanding. These approaches may utilize prompt engineering techniques where the system provides carefully crafted instructions to the Large Language Model to identify narrative themes, extract key concepts, or categorize content based on semantic relationships within the text. The system may employ zero-shot topic modeling where the Large Language Model analyzes social media content without prior training on specific topic categories, relying on its pre-trained knowledge to identify and label emerging themes within the discourse. Few-shot learning approaches may be implemented where the system provides the Large Language Model with a small number of examples of desired topic classifications, enabling the model to generalize these patterns to identify similar thematic elements across larger datasets.

Embedding-based clustering approaches may combine Large Language Model text embeddings with traditional clustering algorithms to group semantically similar content into coherent topic categories. The system may generate high-dimensional vector representations of social media posts using Large Language Models and apply clustering techniques to identify groups of posts that share similar semantic characteristics, with the Large Language Model subsequently providing interpretable labels for the discovered clusters. Chain-of-thought prompting techniques may be employed where the system guides the Large Language Model through step-by-step reasoning processes to identify topics by first extracting key entities, then analyzing relationships between these entities, and finally synthesizing these relationships into coherent thematic categories. The system may implement iterative refinement approaches where initial topic classifications generated by the Large Language Model are validated against the original text data and refined through multiple passes to improve accuracy and coherence.

Specific implementations may include using models using prompts designed to analyze collections of social media posts and identify recurring narrative themes by examining linguistic patterns, semantic relationships, and contextual associations within the text. The system may employ BERT-based models to generate contextual embeddings of social media content that capture nuanced semantic relationships, enabling the identification of topics that share conceptual similarity even when using different terminology. T5 or similar sequence-to-sequence models may be utilized to transform social media posts into standardized topic descriptions, enabling consistent categorization across diverse content types and linguistic styles. The system may implement conversational models to engage in multi-turn analysis processes where the model iteratively refines topic identification through structured dialogue that explores different aspects of the content and validates thematic consistency across related posts.

A computer device may comprise several interconnected components that enable the processing and analysis of social media data for authenticity detection purposes. The device may include one or more processors configured to execute computational algorithms and statistical analysis operations, memory systems that store both temporary working data and persistent information such as flag definitions and analytical models, and storage components that maintain databases of social media content, account information, and historical analysis results. The computer device may incorporate input/output interfaces that facilitate communication with external social media platforms and data sources, enabling the collection of message data and account characteristics for processing. Network communication capabilities may allow the device to interface with distributed social media listening platforms and coordinate data collection across multiple platforms simultaneously. The device may include specialized processing modules or software components that implement natural language processing techniques, statistical outlier detection algorithms, and account linking mechanisms. Display systems may be integrated to present analytical results, visualizations, and network graphs to analysts for interpretation and decision-making. These components may operate together through coordinated data processing workflows that systematically analyze social media activity patterns to identify coordinated influence operations through the examination of behavioral flags, objects of influence, and statistical distributions across social media discourse areas.

Machine readable storage including machine-readable instructions, when executed, to implement a method or realize an apparatus in any of the examples of the present application.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another but are to be considered as separate and autonomous representations of the present invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

What is claimed is:

1. A computerized system for authenticity analysis of social media activity, comprising:
a computer device configured to receive social media data from a social media platform;
a memory configured to store a set of flags, wherein each flag represents an indicator that a social media account may be participating in a coordinated influence operation;
the computer device is further configured to:
identify a topic within the social media data,
define a set of objects of influence within the topic,
assign one or more flags from the set of flags to social media accounts based on account attributes,
calculate rates at which the flags appear connected to each object of influence,
perform statistical analysis to detect outlier objects of influence based on flag distributions that deviate from expected patterns,
identify accounts that contribute to the outlier objects of influence as suspected of participating in coordinated influence operations and,
display on a display the identified accounts.

2. The computerized system of claim 1, wherein the flags comprise indicators of automation including hyperactivity patterns, implausibly regular output schedules, birth bunch, narrow retweeter, low follower, usage of automation-friendly client applications and any combination.

3. The computerized system of claim 2, wherein the hyperactivity patterns are detected by analyzing posting frequency that exceeds expected human behavior thresholds.

4. The computerized system of claim 1, wherein the objects of influence comprise hashtags, external domains, named entities, account mentions, narrative themes and any combination identified through natural language processing techniques.

5. The computerized system of claim 4, wherein the narrative themes are identified using Large Language Model-based topic modeling approaches that analyze terms appearing together with statistical significance.

6. The computerized system of claim 1, wherein the computer device is further configured to link accounts that contribute to the same outlier object of influence and share the flag that caused the object to be identified as an outlier.

7. The computerized system of claim 6, wherein the computer device is further configured to identify secondary linkages between accounts that simultaneously contribute to multiple outlier objects exhibiting similar statistical anomalies.

8. A computerized method for detecting coordinated influence operations on social media platforms, comprising:
receiving social media data from a social media platform;
storing a set of flags, wherein each flag represents an indicator that a social media account may be participating in a coordinated influence operation;
identifying a topic within the social media data;
defining a set of objects of influence within the topic;
assigning one or more flags from the set of flags to social media accounts based on account attributes;
calculating rates at which the flags appear connected to each object of influence;
performing statistical analysis to detect outlier objects of influence based on flag distributions that deviate from expected patterns;
identifying accounts that contribute to the outlier objects of influence as suspected of participating in coordinated influence operations, and
providing the identified account to a user for subsequent action by the user.

9. The computerized system of claim 8, wherein the flags comprise indicators of automation including hyperactivity patterns, implausibly regular output schedules, birth bunch, narrow retweeter, low follower, usage of automation-friendly client applications and any combination.

10. The computerized method of claim 9, wherein the hyperactivity patterns are detected by analyzing posting frequency that exceeds expected human behavior thresholds.

11. The computerized method of claim 8, wherein the objects of influence comprise hashtags, external domains, named entities, account mentions, narrative themes and any combination identified through natural language processing techniques.

12. The computerized method of claim 11, wherein the narrative themes are identified using Large Language Model-based topic modeling approaches that analyze terms appearing together with statistical significance.

13. The computerized method of claim 8, further comprising a step of linking accounts that contribute to the same outlier object of influence and share the flag that caused the object to be identified as an outlier.

14. The computerized method of claim 13, further comprising a step of identifying secondary linkages between accounts that simultaneously contribute to multiple outlier objects exhibiting similar statistical anomalies.

15. A computer device having a computer readable medium and computer readable instructions that, when executed by a processor, comprise:
receiving a social media data from one or more social media platforms;
storing a set of flags, wherein each flag represents an indicator that a social media account may be participating in a coordinated influence operation;
identifying a topic within the social media data;
defining a set of objects of influence within the topic;
assigning one or more flags from the set of flags to social media accounts based on account attributes;
calculating rates at which the flags appear connected to each object of influence;
performing statistical analysis to detect outlier objects of influence based on flag distributions that deviate from expected patterns; and
identifying accounts that contribute to the outlier objects of influence as suspected of participating in coordinated influence operations.

16. The computerized system of claim 15, wherein the flags comprise indicators of automation including hyperactivity patterns, implausibly regular output schedules, birth bunch, narrow retweeter, low follower, usage of automation-friendly client applications and any combination.

17. The computer device of claim 16, wherein the hyperactivity patterns are detected by analyzing posting frequency that exceeds expected human behavior thresholds.

18. The computer device of claim 15, wherein the objects of influence comprise hashtags, external domains, named entities, account mentions, narrative themes and any combination are identified through natural language processing techniques.

19. The computer device of claim 18, wherein the narrative themes are identified using Large Language Model-based topic modeling approaches that analyze terms appearing together with statistical significance.

20. The computer device of claim 15, wherein the computer readable instructions further cause the processor to link accounts that contribute to the same outlier object of influence and share the flag that caused the object to be identified as an outlier.
